(19) United States
(12) Patent Application Publication
(10) Pub. No.: US 2008/0025350 A1
(43) Pub. Date: Jan. 31, 2008

(54) Wavelength combining using a arrayed waveguide grating having a switchable output

(75) Inventors: Mark A. Arbore, Los Altos, CA (US); Gregory D. Miller, Sunnyvale, CA (US)

Correspondence Address: LUMEN INTELLECTUAL PROPERTY SERVICES, INC., 2345 YALE STREET, SECOND FLOOR, PALO ALTO, CA, 94306, US

(73) Assignee: Collinear Corporation

(21) Appl. No.: 11/904,775

(22) Filed: Sep. 27, 2007

Related U.S. Application Data
(63) Continuation-in-part of application No. 11/732,584, filed on Apr. 3, 2007.
(60) Provisional application No. 60/788,932, filed on Apr. 3, 2006.

(51) Int. Cl. H01S 3/10; G02B 6/26

(52) U.S. Cl. 372/20; 385/17

(57) ABSTRACT

Switchable power combining is provided using a tunable arrayed waveguide grating (AWG) as the combining element. The AWG has two or more inputs and two or more outputs. Each AWG input is bi-directionally coupled to a corresponding laser source, and each laser source has substantially the same gain spectrum. All sources are coupled to a selected one of the AWG outputs, without substantial coupling of the sources to any other AWG output. The AWG is tunable, such that any one of its outputs can be thus selected. The selected output provides optical feedback, thereby feedback stabilizing the emission wavelengths of the sources to values suitable for single-mode combining. According to a further aspect of the invention, a piezo-electrically tunable AWG is provided. The AWG has a piezo-electric transducer bonded to the waveguide array section of the AWG. Strain induced in the waveguide array by the transducer can alter optical path lengths of the waveguide, thereby tuning the AWG.

### CROSS REFERENCE TO RELATED APPLICATIONS

This application is a continuation in part of U.S. application Ser. No. 11/732,584, filed on Apr. 3, 2007, and entitled “Piezo-Electrically Tunable and Switchable Arrayed Waveguide Grating”. application Ser. No. 11/732,584 claims the benefit of U.S. provisional patent application 60/788,932, filed on Apr. 3, 2006, and entitled “Piezo-Electrically Tunable and Switchable Arrayed Waveguide Grating”.

### FIELD OF THE INVENTION

This invention relates to wavelength combining of feedback-stabilized laser sources.

### BACKGROUND

Wavelength combining is an approach for providing a high power, high brightness optical radiation source by combining the outputs of several emitters having non-overlapping optical spectra. Such combination can be into a single spatial mode (e.g., a single mode fiber or a single mode waveguide), because of the non-overlapping spectra of the emitters. A simple example of wavelength combining would be coupling two lasers emitting at fixed separate wavelengths λ₁ and λ₂ to a single mode optical fiber with an appropriate wavelength division multiplexing (WDM) coupler. Another example of wavelength combining can be referred to as intra-cavity wavelength combining, where each emitter is a gain element of an external cavity laser, and the resulting set of external cavity lasers shares a common output coupler. By inserting a dispersive optical element into this arrangement, the lasing wavelengths of each of the external cavity lasers can be made distinct, thereby providing wavelength combining. U.S. Pat. No. 6,192,062 provides one example of such an approach.

Feedback stabilized wavelength combining is another approach for wavelength combining. In this approach, wavelength selective feedback is provided to several laser oscillator sources. Such feedback can effectively set the emission wavelength of the source to coincide with the wavelength (or wavelength range) fed back to the source. An efficient way to provide appropriate feedback is to couple the sources to a WDM combiner that has a partial reflection at its output that provides feedback to its inputs. Such feedback automatically tends to set the source laser emission wavelengths to the appropriate values for efficient wavelength combining. U.S. Pat. No. 6,567,580 and U.S. Pat. No. 6,052,394 consider this approach.

Feedback stabilized wavelength combining has been performed using an arrayed waveguide grating (AWG) as the wavelength combining element, e.g., as considered in U.S. Pat. No. 6,931,034. In an AWG a set of input waveguides is coupled to a first star coupler, and a set of output waveguides is coupled to a second star coupler. An array of waveguides is connected between the first and second star couplers, each waveguide of the array having a different length. An AWG can perform wavelength combining, such that inputs at several of the input waveguides having different wavelengths are coupled to the same output waveguide. Further information relating to AWGs can be found in U.S. Pat. No. 6,359,912, U.S. Pat. No. 6,766,074, U.S. Pat. No. 6,385,353, U.S. Pat. No. 6,853,773, U.S. Pat. No. 6,654,392, U.S. Pat. No. 7,139,455, and U.S. Pat. No. 6,798,929.

For some applications, it is desirable to switch the wavelength combined radiation such that it can be coupled to any of two or more optical ports. Although optical switches are well-known and have been extensively investigated, it remains difficult to provide switches for demanding applications (e.g., requiring high power handling capacity combined with a short switching time).

Accordingly, it would be an advance in the art to provide high power wavelength combining having a rapidly switchable output.

### SUMMARY

Switchable power combining is provided using a tunable arrayed waveguide grating (AWG) as the combining element. The AWG has two or more inputs and two or more outputs. Each AWG input is bi-directionally coupled to a corresponding laser source, and each laser source has substantially the same gain spectrum. All sources are coupled to a selected one of the AWG outputs, without substantial coupling of the sources to any other AWG output. The AWG is tunable, such that any one of its outputs can be thus selected. The selected output provides optical feedback, thereby feedback stabilizing the emission wavelengths of the sources to values suitable for single-mode combining.

According to a further aspect of the invention, a piezo-electrically tunable AWG is provided. The AWG has a piezo-electric transducer bonded to the waveguide array section of the AWG. Strain induced in the waveguide array by the transducer can alter optical path lengths of the waveguide, thereby tuning the AWG.

### BRIEF DESCRIPTION OF THE DRAWINGS

FIG. 1 shows a power combined optical source having a switchable output according to an embodiment of the invention.

FIGS. 2a-b show how the system of FIG. 1 operates in two different switching states.

FIG. 3 shows how periodic wavelength response of an AWG can affect the operation of the system of FIG. 1.

FIG. 4 shows another example of how periodic wavelength response of an AWG can affect the operation of the system of FIG. 1.

FIG. 5 shows a tunable AWG according to an embodiment of the invention.

FIG. 6 shows a tunable AWG according to another embodiment of the invention.

FIG. 7 shows a tunable AWG according to yet another embodiment of the invention.

FIG. 8 shows a tunable AWG according to a further embodiment of the invention.

### DETAILED DESCRIPTION

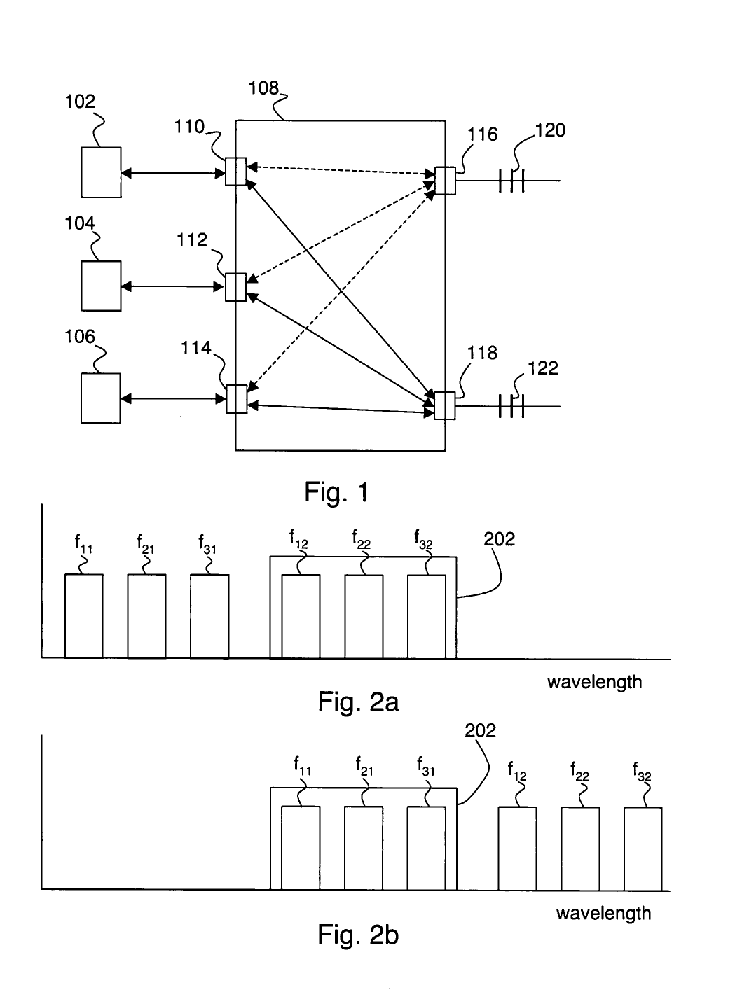

FIG. 1 shows a power combined optical source having a switchable output according to an embodiment of the invention. Two or more laser sources, here shown as 102, 104, and 106, and each having substantially the same gain spectrum, are coupled to an arrayed waveguide grating (AWG) coupler 108. Any such laser sources can be employed to practice the invention, although laser diodes are preferred. As used herein, laser diodes having the same nominal design are regarded as having “substantially the same gain spectrum”, since ordinary lot to lot and device to device laser diode output spectral variation is not a critical factor in practicing the invention. AWG 108 has two or more input ports, here shown as 110, 112, and 114, and has two or more output ports, here shown as 116 and 118. Each input port is bi-directionally coupled to one of the laser sources, such that radiation can propagate from the source to the input port, and from the input port to the source. Input ports 110, 112, and 114 are coupled to sources 102, 104, and 106 respectively.

Radiation from all of the laser sources is coupled to a selected one of the output ports by AWG 108, without substantial coupling of radiation to any other output port. AWG 108 is tunable, such that any of the output ports can be selected at the port to which the inputs are coupled. Thus there are two switching states in the example of FIG. 1. In the first state (solid lines), all inputs are coupled to output port 118. In the second state (dashed lines), all inputs are coupled to output port 116. Although any method of tuning the AWG can be employed, it is preferred for piezo-electric tuning to be employed, as described in greater detail below. Such piezo-electric tuning can provide rapid tunability (e.g., 1 kHz and greater switching frequency, or equivalently, 1 ms or less switching time).

The selected output port provides a predetermined level of optical feedback to the input ports. In this example, when output port 118 is selected, its feedback is predetermined by a partial reflector 122. Similarly, when output port 116 is selected, its feedback is provided by a partial reflector 120. Practice of the invention does not depend on how partial reflection is implemented. In preferred embodiments of the invention where the input and output ports are waveguide-coupled, partial reflection can be implemented with a waveguide grating, waveguide interface, single-layer or multi-layer dielectric coating on a surface or interface, or other waveguide perturbation.

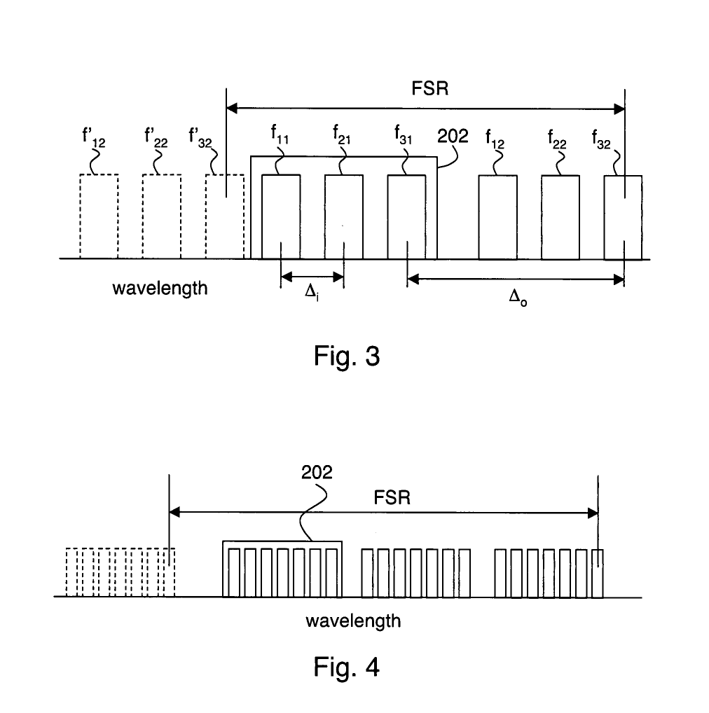

Basic operation of the system of FIG. 1 can be appreciated in connection with FIGS. 2a-b. Here the notation fᵢⱼ is introduced to refer to the spectral response of the AWG between input i and output j. Thus f₃₂ is the response seen between input 3 and output 2, and similarly for the other labeled responses on FIGS. 2a-b. The responses fᵢⱼ on FIGS. 2a-b are shown as idealized “brick-wall” bandpass transfer functions for simplicity of explanation. Practice of the invention does not depend on the details of how real AWG bandpass responses differ from the idealized responses shown here. In contrast, the effect of the AWG free spectral range is important in practicing the invention, and is discussed below in connection with FIGS. 3 and 4.

Thus the wavelengths at which fᵢⱼ is non-zero are the wavelengths at which radiation can propagate from input i to output j, or from output j to input i. The gain spectrum of laser sources 102, 104, and 106 is shown as 202 on FIGS. 2a-b. This gain spectrum is also shown as an idealized “brick-wall” bandpass response, since practice of the invention does not depend on details of how real laser gain spectra differ from an idealized bandpass response.

Tuning the AWG alters the relation between the fᵢⱼ and gain spectrum 202. More specifically, FIG. 2a relates to the situation shown in solid lines on FIG. 1, where all inputs are coupled to output 118 (taken to be output #2). Similarly, FIG. 2b relates to the situation shown in dashed lines on FIG. 1 where all inputs are coupled to output 116 (taken to be output #1).

The feedback provided by partial reflector 120 or by partial reflector 122 is broad-band relative to the source gain spectrum 202. Accordingly, each laser source receives wavelength-selective feedback tending to stabilize the emission wavelength of the source to a wavelength in the feedback band. In the example of FIG. 2a, source 1 is stabilized to a wavelength where f₁₂ is non-zero, source 2 is stabilized to a wavelength where f₂₂ is non-zero, and source 3 is stabilized to a wavelength where f₃₂ is non-zero. Similar wavelength selective feedback is provided in the example of FIG. 2b. In either case, such stabilization of the sources to distinct emission wavelengths enables single-mode combining of radiation from these sources at output port 116 or output port 118.

In preferred embodiments of the invention, the arrangement of FIG. 1 is implemented with waveguide technology (e.g., fiber coupling and/or implementation in single-mode planar lightwave circuitry).

A key aspect of the invention is combining several sources to one single-mode output (e.g., a waveguide), and being able to switch the combined radiation from one output to another. Although this functionality could be provided by combining a single-output combiner with a 1:N switch, it is preferable to avoid a separate switch. However, it is possible for the finite free spectral range of the AWG to interfere with providing the desired switching functionality. Accordingly, it is important to identify AWG design conditions conducive to switching of power combined outputs.

FIG. 3 shows how periodic wavelength response of an AWG can affect the operation of the system of FIG. 1. Here, several AWG parameters are defined. The input channel spacing Δᵢ is the wavelength spacing of adjacent input channels coupled to the same output channel. The output channel spacing Δₒ is the wavelength spacing of adjacent output channels coupled to the same input channel. The AWG channel responses are approximately periodic in the relevant wavelength range, and the free spectral range (FSR) of the AWG is the wavelength period of each response fᵢⱼ. Thus, f₁₂′, f₂₂′ and f₃₂′ on FIG. 3 are related to f₁₂, f₂₂, and f₃₂ respectively by the FSR. For simplicity, the input channels are assumed to have evenly spaced wavelengths and the output channels are also assumed to have evenly spaced wavelengths. The principles developed in connection with this example are also applicable to situations with unevenly spaced input and/or output channels. We also assume M input channels and N output channels, and let Δ_{G} be the source gain bandwidth (i.e., the width of spectrum 202).

From FIG. 3, several requirements are apparent. First, we have MΔᵢ<Δ_{G}, because all of the inputs must simultaneously fit within the source gain spectrum. The second condition is that a single input must not couple to two outputs in the source gain bandwidth. There are two ways the second condition can be violated, and it is convenient to refer to these two possibilities as “direct overlap” and “aliased overlap”. Direct overlap occurs if the output channel spacing is too small (e.g., f₁₁ and f₁₂ both fall within source gain spectrum 202). Direct overlap is avoided if Δ_{G}<Δₒ. Aliased overlap occurs if the FSR is too small (e.g., f₃₁ and f₃₂′ both fall within source gain spectrum 202). Aliased overlap is avoided if Δ_{G}+(N−1)Δₒ<FSR. Since Δ_{G}<Δₒ, aliased overlap can also be avoided by imposing the simpler and more restrictive condition NΔₒ<FSR. FIG. 4 shows an example with three outputs, which demonstrates that an FSR on the order of NΔₒ avoids aliased overlap.

As indicated above, a preferred tuning mechanism for AWG 108 is piezo-electric tuning, although any method of AWG tuning can be employed to practice switchable power combining according to embodiments of the invention.

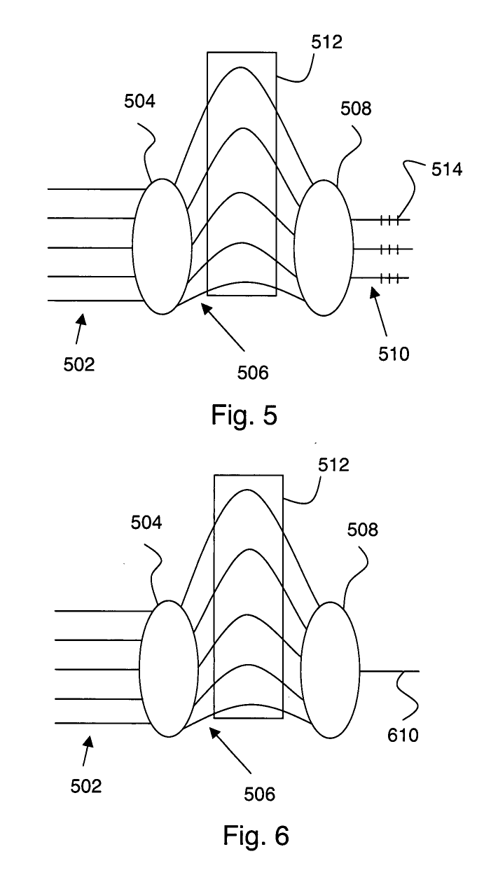

FIG. 5 shows a piezo-electrically tunable AWG according to an embodiment of the invention. In this example, a waveguide array 506 connects a first star coupler 504 to a second star coupler 508. Waveguides 506 have different lengths between the two star couplers. Waveguides 502 are coupled to first star coupler 504, and waveguides 510 are coupled to second star coupler 508. A piezo-electric element 512 is bonded to waveguide array 506 such that an electrical signal applied to element 512 induces strain in the waveguides of array 506.

The strain alters the optical path lengths of waveguide 506. Strain can affect the optical path length of the waveguides by altering the physical path length and/or by altering the effective refractive index via the strain-optic effect. Since AWG waveguides have different physical lengths, the relative phase shift from one waveguide to the next will vary even if the strain (and resulting index change) is the same for the two waveguides. Accordingly, only a single tuning input is needed to tune the AWG.

In this manner, the wavelength response from any of waveguides 502 to any of waveguides 510 can be tuned. This configuration is suitable for switchable pump laser power combining, where each pump laser is coupled to one of waveguides 502, and feedback from a selected one of waveguides 510 acts to stabilize each pump laser wavelength such that the total optical pump power is efficiently provided to the selected waveguide. Such feedback can be provided by partial reflectors in the output waveguides, one of which is labeled as 514 on FIG. 5. Tuning the AWG can switch the combined output from one of waveguides 510 to another of waveguides 510 as described above.

Practice of the invention does not depend critically on details of the arrayed waveguide grating dimensions or material, although planar silica lightwave circuit technology is a preferred approach. Similarly, practice of the invention does not depend on geometrical or compositional details of the piezo-electric transducer bonded to the arrayed waveguides. Piezo transducer materials having a high figure of merit (FOM) are preferred. The FOM is given by the product of the modulus of elasticity and the piezo-electric coefficient d31 (which relates in-plane strain to across-plane voltage.) It is preferred for the piezo-electric strain to be applied in the plane of waveguides 506 as opposed to perpendicular to this plane. This arrangement is preferred because it is relatively simple to implement, and it also provides good uniformity of applied strain to the AWG. By applying a substantially uniform strain to the AWG, distortions to the AWG passband spectrum shape that may occur during tuning are desirably minimized, thereby minimizing efficiency losses caused by tuning.

AWG tuning as described above has several advantages compared to conventional tuning approaches. First, only a single tuning input is necessary, which is much simpler than approaches which require individual tuning inputs for each of waveguides 506. In practice, waveguides 506 may include tens or hundreds of waveguides, so having one input per waveguide is frequently impractical. Second, tuning is provided without requiring AWG waveguides 506 to be fabricated of materials having unusual optical properties (e.g., piezo-electric and/or electro-optic materials). Instead, centro-symmetric materials can be employed for the AWG waveguides, and planar silica waveguides are preferred. This advantageously avoids many difficulties associated with fabricating waveguides in piezo-electric and/or electro-optic materials. Third, tuning is electrical and can be performed rapidly (e.g., kHz rates and up), as opposed to thermal tuning approaches which tend to be substantially slower than 1 kHz.

For example, one thermal tuning approach is based on affixing an AWG to a temperature controlled mount having a different coefficient of thermal expansion (CTE) than the AWG (e.g., Al, with a CTE of about 20 ppm/C). By altering the temperature of this mount, the strain in the attached AWG can be altered, thereby tuning it. However, as indicated above, this tuning method does not provide rapid tuning.

FIG. 6 shows a tunable arrayed waveguide grating according to another embodiment of the invention. In this embodiment, second star coupler 508 is coupled to a single waveguide 610. AWG tunability can be useful in connection with a single output AWG in various ways (e.g., by improving alignment of AWG channels with the source gain spectrum to accommodate manufacturing tolerances).

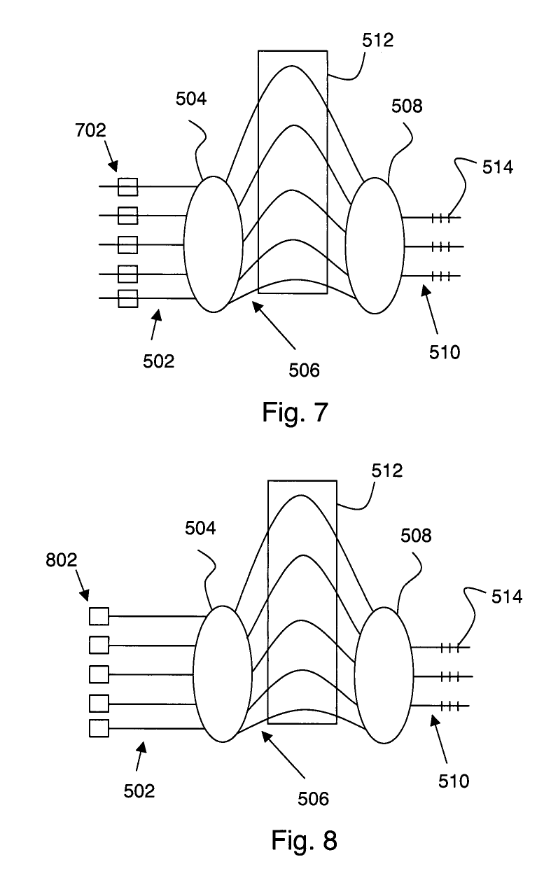

Tunable AWGs according to embodiments of the invention can be combined with fixed spectral filters to provide switching functionality. This functionality can be provided in various ways. FIG. 7 shows an example where fixed spectral filters 702 are provided on input waveguides 502. The combination of fixed filters 702 and the tunable filter functionality provided by the tunable AWG provides switching capability. Another approach for providing switching functionality is shown on FIG. 8. Here sources 802 are band-limited sources (e.g., laser diodes having a gain spectrum). The band-limiting of the sources acts analogously to the fixed filters 702 of FIG. 7 in providing switching capability, so the source gain spectrum can be regarded as a “fixed filter” in this context.

An experiment has been performed to demonstrate this tuning approach. A 16-channel AWG with a center passband wavelength of 980 nm was employed. Using epoxy, a piezo transducer was glued to the top surface of the AWG. The waveguide array was buried about 10 microns below the glued surface. The adhesive was thin (perhaps <50 microns) and very rigid. The piezo transducer was glued over the arrayed waveguide section, but not over the free-propagation sections of the structure. The piezo transducer extended over the edge of the AWG chip, thereby providing electrical access to both sides of the piezo material. The piezo transducer was connected to a high-voltage source capable of ±210 Volts. The Silicon wafer (modulus of elasticity ˜110 GPa) onto which the AWG was fabricated was 650 microns thick, while the piezo transducer (modulus of elasticity ˜61 GPa) was 750 microns thick. A tunable ˜980 nm diode laser was launched into the AWG, and the wavelength was adjusted for maximum transmission on one channel when −210V was applied to the piezo transducer. Then, the voltage was changed to +210V. The transmitted power dropped to ˜10% of the original power. By tuning the laser by 0.1 nm, all of the original power was recovered. Hence, a 420 Volts change provided 0.1 nm of tuning.

Several approaches can be used to increase the tuning rate with respect to applied voltage. Increasing the thickness of the piezo transducer does not help significantly because the effects of increased stiffness (roughly proportional to thickness) and decreased electric field strength (inversely proportional to thickness) tend to cancel. Decreasing the thickness of the silicon that supports the AWG does, however, help. It is not difficult to thin silicon wafers to 100 um, or below. This could improve the tuning rate by >5×. Shaping the piezo-strained region over the arrayed waveguides such that longer waveguides have more of their length subject to strain than shorter waveguides would also help, perhaps by about 2×. Increasing the physical size of the AWG (and hence the difference in lengths between the long and short waveguides) increases the tuning effect, in proportion to this increase in length. Looked at another way, the wavelength tuning rate is proportional to the FSR of the AWG, which is tied to the difference in waveguide lengths. This could provide another ˜2× improvement. Also, two piezo transducers could be used, by sandwiching the AWG between the two piezo transducers, electrically connected in parallel, generating another 2× improvement.

1. A source of optical radiation, the source comprising:
two or more laser sources, each having substantially the same source gain spectrum, said gain spectrum having a source gain bandwidth;
an arrayed waveguide grating coupler having two or more input ports and having two or more output ports, wherein each input port is bi-directionally optically coupled to a corresponding one of said laser sources;
wherein laser source radiation from all of said laser sources is coupled to a selected one of said output ports by said arrayed waveguide grating coupler, without substantial coupling of said laser source radiation to any other of said output ports;
wherein said selected output port provides a predetermined level of optical feedback of said laser source radiation to said input ports;
wherein said arrayed waveguide grating coupler is tunable such that said selected output port can be selected from any of said output ports.

2. The optical source of claim 1, wherein a spectral spacing of said output ports is greater than said source gain bandwidth.

3. The optical source of claim 1, wherein said arrayed waveguide grating has N said output ports, wherein a spectral spacing of said output ports is given by Δₒ, and wherein NΔₒ is less than a free spectral range of said arrayed waveguide grating.

4. The optical source of claim 1, wherein said arrayed waveguide grating has M said input ports, wherein a spectral spacing of said input ports is given by Δᵢ, and wherein MΔᵢ is less than said source gain bandwidth.

5. The optical source of claim 1, wherein said laser sources comprise laser diodes.

6. The optical source of claim 1, wherein said arrayed waveguide grating coupler is piezo-electrically tunable.

7. The optical source of claim 1, wherein said arrayed waveguide grating can be tuned from one of said output ports to another of said output ports in less than about 1 ms.

8. A tunable optical filter comprising:
a first star coupler having one or more input waveguides and coupled to a waveguide array having two or more waveguides;
a second star coupler coupled to said waveguide array and having one or more output waveguides, wherein said waveguides of said waveguide array have different lengths between said first star coupler and said second star coupler;
a slab of piezo-electric material bonded to said waveguide array, such that varying an electrical signal input to said piezo-electric material causes a corresponding variation in a mechanical strain of all or part of said waveguide array;
wherein said variation of said mechanical strain alters optical path lengths of said waveguides of said waveguide array, whereby tunability of wavelength responses from said one or more input waveguides to said one or more output waveguides is provided.

9. The tunable optical filter of claim 8, wherein said variation of said mechanical strain alters said optical path lengths of said waveguides via one or more physical mechanisms selected from the group consisting of altering physical path lengths of said waveguides and altering effective refractive indices of said waveguides via a strain-optic effect.

10. The tunable optical filter of claim 8, wherein said mechanical strain is primarily in a plane of said waveguide array.

11. The tunable optical filter of claim 8, wherein said waveguide array comprises centro-symmetric materials.

12. The tunable optical filter of claim 8, wherein said waveguide array comprises planar silica waveguides.

13. The tunable optical filter of claim 8, wherein one or more of said output waveguides provides a partial reflection of radiation incident from said second star coupler.

14. A switch comprising the tunable optical filter of claim 8 in combination with a fixed optical filter.

15. The switch of claim 14, wherein said fixed optical filter comprises a gain spectrum of a laser source.
